(19) United States
(12) Patent Application Publication
(10) Pub. No.: US 2025/0329292 A1
(43) Pub. Date: Oct. 23, 2025

(54) DISPLAY DEVICE AND ELECTRONIC APPARATUS INCLUDING THE SAME

(71) Applicant: Samsung Display Co., Ltd., Yongin-Si (KR)

(72) Inventor: WOUNG KIM, Yongin-si (KR)

(21) Appl. No.: 19/011,598

(22) Filed: Jan. 7, 2025

(30) Foreign Application Priority Data
Apr. 23, 2024 (KR) 10-2024-0054134

(51) Int. Cl. G09G 3/32

(52) U.S. Cl. CPC G09G 3/32; G09G 2310/0267; G09G 2310/0275; G09G 2310/08; G09G 2320/0276; G09G 2330/021

(57) ABSTRACT

A display device includes a display panel including a pixel, a data driver generating a first data voltage for a low driving frequency based on a low-frequency gamma voltage, generating a second data voltage for a high driving frequency based on a high-frequency gamma voltage, and providing the first data voltage or the second data voltage to the pixel, and a scan driver generating a first scan signal for the low driving frequency having a low-frequency scan-on time, generating a second scan signal for the high driving frequency having a high-frequency scan-on time, and providing the first scan signal or the second scan signal to the pixel. The low-frequency scan-on time may be determined when a difference between a low-frequency gamma voltage range of a low-frequency gamma voltage and a target gamma voltage range is within a reference range.

### CROSS-REFERENCE TO RELATED APPLICATION(S)

This application claims priority under 35 USC § 119 to Korean Patent Application No. 10-2024-0054134 filed on Apr. 23, 2024, in the Korean Intellectual Property Office (KIPO), the entire disclosure of which is incorporated by reference herein.

### BACKGROUND

### 1. Field

Embodiments of the present disclosure relate to a display device. More particularly, the present disclosure relates to a display device having an improved display quality in a variable driving frequency and an electronic apparatus including the display device.

### 2. Description of the Related Art

A display device may include a display panel that displays an image, a data driver that provides a data voltage to the display panel, a scan driver that provides a scan signal to the display panel, and an emission driver that provides an emission signal to the display panel. Recently, a variable refresh rate (VRR) driving method that adjusts a driving frequency of the display panel has been developed to improve quality of an image displayed on the display device and to reduce power consumption of the display device, etc.

During a transition of the driving frequency of the display device or when the display device switches from a display-off state to a display-on state, flashing in which a luminance of the image increases or decreases may be recognized due to different driving conditions, changes in an emission cycle and an emission-off time of the emission signal, etc. based on the driving frequency. As a result, the image quality of the display device may deteriorate.

### SUMMARY

Embodiments of the present disclosure provide a display device having an improved image quality during the transition of driving frequency or when switching from a display-off state to a display-on state, and an electronic apparatus including the display device.

According to an embodiment of the present disclosure, a display device includes a display panel including a pixel, a data driver connected to the pixel through a data line, and a scan driver connected to the pixel through a gate line. The data driver may generate a first data voltage for a low driving frequency based on a low-frequency gamma voltage, generate a second data voltage for a high driving frequency higher than the low driving frequency based on a high-frequency gamma voltage, and provide the first data voltage or the second data voltage to the pixel. The scan driver may generate a first scan signal for the low driving frequency having a low-frequency scan-on time, generate a second scan signal for the high driving frequency having a high-frequency scan-on time different from the low-frequency scan-on time, and provide the first scan signal or the second scan signal to the pixel. The low-frequency scan-on time may be determined when a difference between a low-frequency gamma voltage range of a low-frequency gamma voltage and a target gamma voltage range calculated based on a high-frequency gamma voltage range of a high-frequency gamma voltage is within a reference range.

In an embodiment, the target gamma voltage range may be equal to the high-frequency gamma voltage range.

In an embodiment, the low-frequency gamma voltage range may be defined from a first reference low-frequency gamma voltage corresponding to a first reference grayscale to a second reference low-frequency gamma voltage corresponding to a second reference grayscale higher than the first reference grayscale, and the target gamma voltage range may be defined from a first reference high-frequency gamma voltage corresponding to the first reference grayscale to a second reference high-frequency gamma voltage corresponding to the second reference grayscale.

In an embodiment, the low-frequency scan-on time may decrease by an offset when the low-frequency gamma voltage range is higher than the target gamma voltage range, and the low-frequency scan-on time may increase by the offset when the low-frequency gamma voltage range is lower than the target gamma voltage range.

In an embodiment, the offset may be determined based on a difference between the low-frequency gamma voltage range and the target gamma voltage range.

In an embodiment, the offset may have a predetermined value.

In an embodiment, the display device may further include an emission driver connected to the pixel through an emission signal line, and a controller generating an emission start signal. The emission driver may generate an emission signal based on the emission start signal having an emission cycle that varies depending on a driving frequency and providing the emission signal to the pixel.

In an embodiment, a buffer frame may be inserted between a low-frequency frame driven at the low driving frequency and a high-frequency frame driven at the high driving frequency when the driving frequency changes between the low driving frequency and the high driving frequency, and a buffer emission cycle of the emission start signal in the buffer frame may be calculated based on a low-frequency emission cycle of the emission start signal in the low-frequency frame and a high-frequency emission cycle of the emission start signal in the high-frequency frame.

According to an embodiment of the present disclosure, a display device includes a display panel including a pixel, an emission driver connected to the pixel through an emission signal line, and a controller generating an emission start signal. The emission driver may generate an emission signal based on the emission start signal having an emission cycle that varies depending on a driving frequency and provide the emission signal to the pixel. A buffer frame may be inserted between a low-frequency frame driven at a low driving frequency and a high-frequency frame driven at a high driving frequency higher than the low driving frequency when the driving frequency changes between the low driving frequency and the high driving frequency, and a buffer emission cycle of the emission start signal in the buffer frame may be calculated based on a low-frequency emission cycle of the emission start signal in the low-frequency frame and a high-frequency emission cycle of the emission start signal in the high-frequency frame.

In an embodiment, the buffer emission cycle may be an average value of the low-frequency emission cycle and the high-frequency emission cycle.

In an embodiment, the buffer emission cycle may be obtained by multiplying a weighted value to an average value of the low-frequency emission cycle and the high-frequency emission cycle.

In an embodiment, the buffer emission cycle when the driving frequency changes from the low driving frequency to the high driving frequency may be different from the buffer emission cycle when the driving frequency changes from the high driving frequency to the low driving frequency.

In an embodiment, the buffer frame may be inserted when a difference between the low driving frequency and the high driving frequency is higher than a threshold frequency.

In an embodiment, the buffer frame may be selectively inserted when the driving frequency changes the low driving frequency to the high driving frequency or when the driving frequency changes from the high driving frequency to the low driving frequency.

In an embodiment, an inserting time of the buffer frame may be delayed by a delay time duration from a transition time of the driving frequency.

According to an embodiment of the present disclosure, a display device includes a display panel including a pixel, an emission driver connected to the pixel through an emission signal line, and a controller generating an emission start signal. The emission driver may generate an emission signal based on the emission start signal having an emission cycle and an emission-off time which vary depending on a driving frequency and provide the emission signal to the pixel. A dummy frame may be inserted before a start frame driven at a start driving frequency when the display panel switches from a display-off state to a display-on state, and at least one of the emission cycle and the emission-off time may be different between the start frame and the dummy frame.

In an embodiment, a dummy emission-off time of the emission start signal in the dummy frame may be greater than a start emission-off time of the emission start signal in the start frame.

In an embodiment, a dummy emission cycle of the emission start signal in the dummy frame may be greater than a start emission cycle of the emission start signal in the start frame.

In an embodiment, the dummy frame may be inserted when the start driving frequency is lower than a threshold frequency.

In an embodiment, an inserting time of the dummy frame may be delayed by a delay time duration from a starting time of the display-on state.

According to an embodiment of the present disclosure, an electronic apparatus includes a display device which displays an image and a processor which controls the display device. The electronic apparatus may include a display panel including a pixel, a data driver connected to the pixel through a data line, and a scan driver connected to the pixel through a gate line. The data driver may generate a first data voltage for a low driving frequency based on a low-frequency gamma voltage, generate a second data voltage for a high driving frequency higher than the low driving frequency based on a high-frequency gamma voltage, and provide the first data voltage or the second data voltage to the pixel. The scan driver may generate a first scan signal for the low driving frequency having a low-frequency scan-on time, generate a second scan signal for the high driving frequency having a high-frequency scan-on time different from the low-frequency scan-on time, and provide the first scan signal or the second scan signal to the pixel. The low-frequency scan-on time may be determined when a difference between a low-frequency gamma voltage range of a low-frequency gamma voltage and a target gamma voltage range calculated based on a high-frequency gamma voltage range of a high-frequency gamma voltage is within a reference range.

In the display device and the electronic apparatus according to the embodiments, the low-frequency scan-on time may be determined to make gamma voltage ranges between the low driving frequency and the high driving frequency become similar during the transition of the driving frequency, or the buffer frame may be inserted between the low-frequency frame and the high-frequency frame, and thus, the image quality may be improved when the driving frequency changes. Further, the dummy frame may be inserted before the start frame when the display device switches from the display-off state to the display-on state, and thus, the image quality may be improved when switching from the display-off state to the display-on state.

### BRIEF DESCRIPTION OF THE DRAWINGS

The above and other features of embodiments of the present disclosure will become more apparent with reference to the descriptions below and the accompanying drawings.

FIG. 1 is a block diagram showing a display device according to an embodiment.

FIG. 2 is a circuit diagram showing a pixel of FIG. 1.

FIG. 3 is a timing diagram showing signals transmitted to the pixel of FIG. 2.

FIG. 4 is a view showing an image displayed when a driving frequency switches from a low driving frequency to a high driving frequency according to a comparative example.

FIG. 5 is a view showing an image displayed when the driving frequency switches from the high driving frequency to the low driving frequency according to a comparative example.

FIG. 6 is a flowchart showing a method of controlling a high-frequency gamma voltage range, a low-frequency gamma voltage range, and a low-frequency scan-on time.

FIG. 7 is a graph describing the method of controlling the low-frequency gamma voltage range.

FIG. 8 is a block diagram showing an example of a controller of FIG. 1.

FIG. 9 is a timing diagram showing an emission start signal when the driving frequency switches according to a comparative example.

FIG. 10 is a timing diagram showing a luminance of an image when the driving frequency switches according to a comparative example.

FIG. 11 is a timing diagram showing the emission start signal when the driving frequency switches according to an embodiment.

FIG. 12 is a timing diagram showing the luminance of the image when the driving frequency switches according to an embodiment.

FIG. 13 is a block diagram showing an example of the controller of FIG. 1.

FIG. 14 is a timing diagram showing the emission start signal when switching from a display-off state to a display-on state according to a comparative example.

FIG. 15 is a timing diagram showing the luminance of the image when switching from the display-off state to the display-on state according to a comparative example.

FIG. 16 is a timing diagram showing the emission start signal when switching from the display-off state to the display-on state according to an embodiment.

FIG. 17 is a timing diagram showing the luminance of the image when switching from the display-off state to the display-on state according to an embodiment.

FIG. 18 is a block diagram showing an electronic apparatus according to an embodiment.

### DETAILED DESCRIPTION OF THE EMBODIMENTS

Hereinafter, a display device and an electronic apparatus according to embodiments of the present disclosure will be described in more detail with reference to the accompanying drawings. The same or similar reference numerals will be used for the same elements in the accompanying drawings.

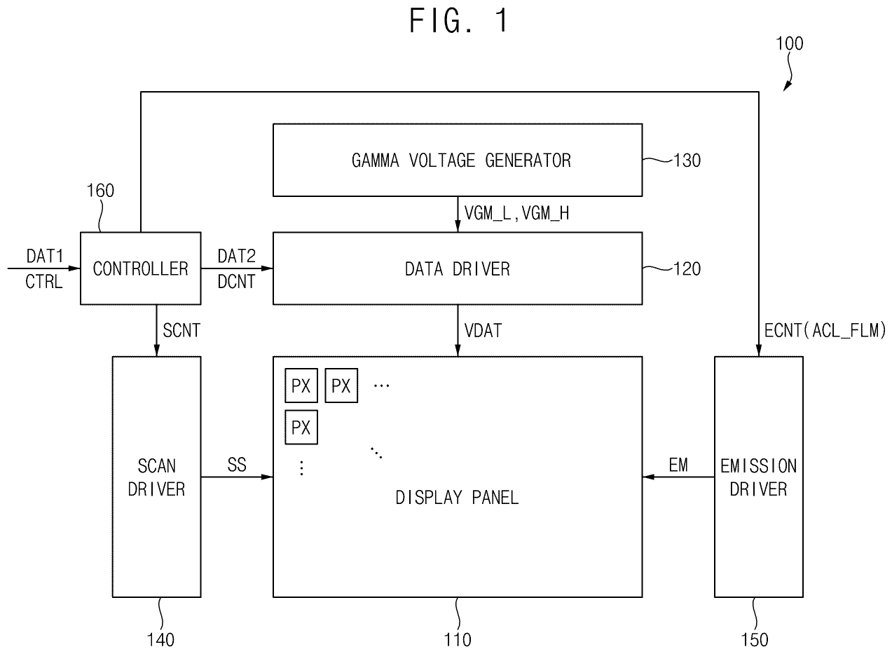

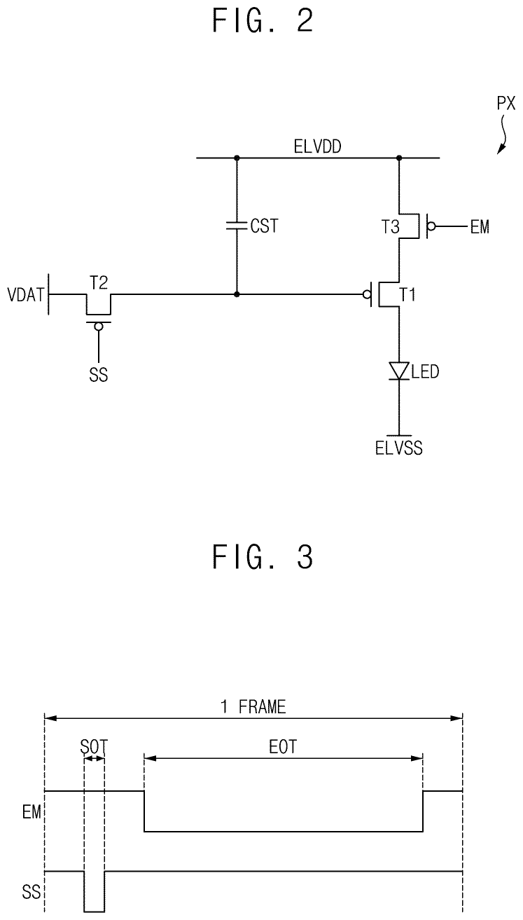

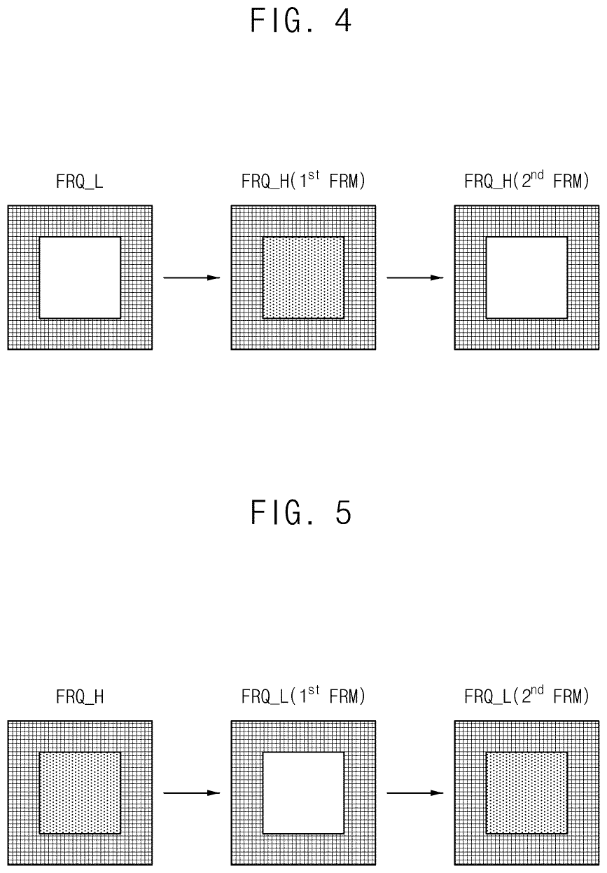

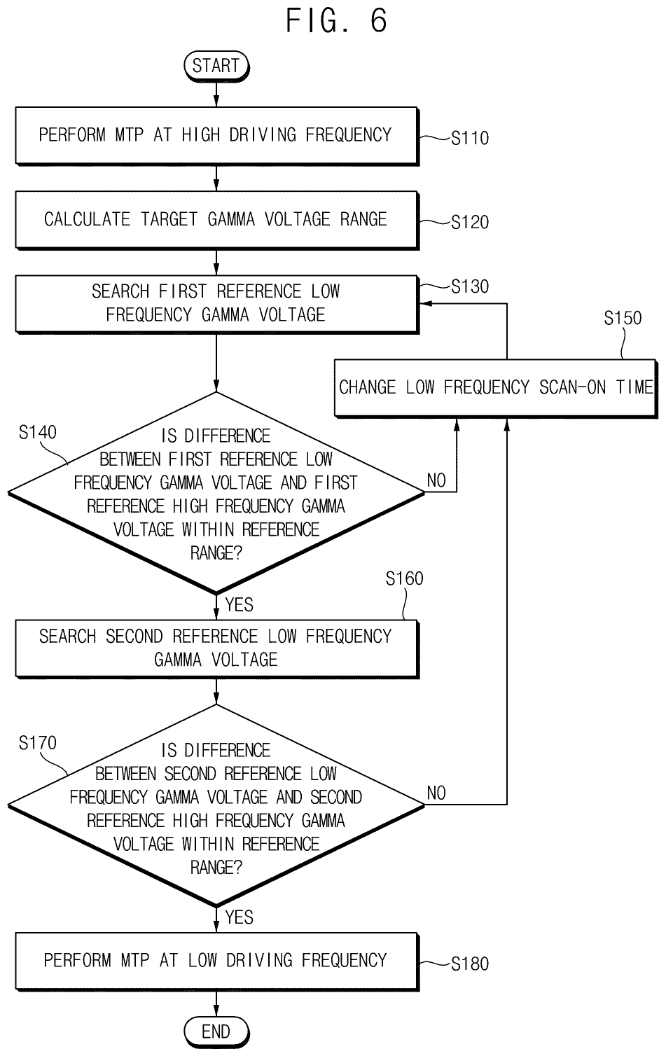

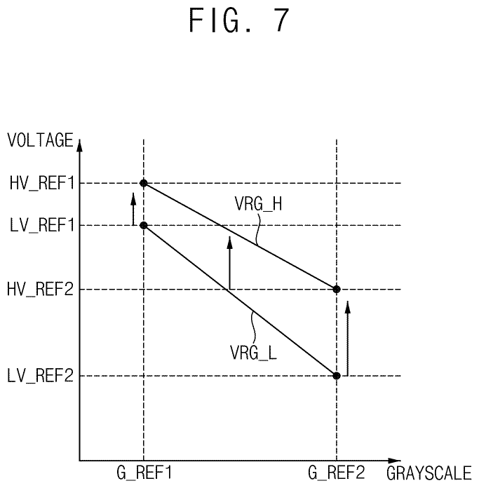

FIG. 1 is a block diagram showing a display device 100 according to an embodiment. FIG. 2 is a circuit diagram showing a pixel PX of FIG. 1. FIG. 3 is a timing diagram showing signals EM and SS transmitted to the pixel PX of FIG. 2. FIG. 4 is a view showing an image displayed when a driving frequency switches from a low driving frequency FRQ_L to a high driving frequency FRQ_H according to a comparative example. FIG. 5 is a view showing an image displayed when the driving frequency switches from the high driving frequency FRQ_H to the low driving frequency FRQ_L according to a comparative example. FIG. 6 is a flowchart showing a method of controlling a high-frequency gamma voltage range VRG_H, a low-frequency gamma voltage range VRG_L, and a low-frequency scan-on time. FIG. 7 is a graph describing the method of controlling the low-frequency gamma voltage range VRG_L.

Referring to FIGS. 1 to 7, a display device 100 may include a display panel 110, a data driver 120, a gamma voltage generator 130, a scan driver 140, an emission driver 150, and a controller 160.

The display panel 110 may display an image. The display panel 110 may be driven by a variable refresh rate (VRR) method in which a driving frequency varies. The driving frequency means a frequency of images displayed on the display panel 110 per second.

The display panel 110 may include a plurality of pixels PX. In an embodiment, as illustrated in FIG. 2, the pixel PX may include a light-emitting element LED, a first transistor T1, a second transistor T2, a third transistor T3, and a storage capacitor CST.

The light-emitting element LED may emit light with a luminance corresponding to a driving current. The first transistor T1 may generate the driving current corresponding to a data voltage VDAT stored in the storage capacitor CST. The second transistor T2 may transmit the data voltage VDAT to a gate of the first transistor T1 in response to a scan signal SS. The third transistor T3 may form a current path through which the driving current flows from a first power voltage ELVDD to a second power voltage ELVSS in response to an emission signal EM. The storage capacitor CST may store the data voltage VDAT transmitted to the gate of the first transistor T1.

Although FIG. 2 illustrates an embodiment in which the pixel PX includes three transistors and one capacitor, the present disclosure is not limited thereto. For example, the pixel PX may include four or more transistors and/or two or more capacitors.

As illustrated in FIG. 3, during a scan-on time SOT in which the scan signal SS has a gate-on voltage (e.g., a gate low voltage), the second transistor T2 may be turned on and the data voltage VDAT may be transmitted to the gate of the first transistor T1 through the second transistor T2. The storage capacitor CST may keep and store the data voltage VDAT transmitted to the gate of the first transistor T1 even after the second transistor T2 is turned off.

During an emission-on time EOT in which the emission signal EM has a gate-on voltage (e.g., a gate low voltage), the third transistor T3 may be turned on and a current path through which the driving current flows from the first power voltage ELVDD to the second power voltage ELVSS may be formed. The driving current may correspond to the data voltage VDAT stored in the storage capacitor CST, and the light-emitting element LED may emit light with a luminance corresponding to the driving current.

The data driver 120 may provide the data voltage VDAT to each of the pixels PX through a plurality of data lines. The data driver 120 may generate the data voltage VDAT based on second image data DAT2, a data control signal DCNT, and a gamma voltage. The data driver 120 may convert the second image data DAT2 into the data voltage VDAT based on the gamma voltage. The gamma voltage may vary depending on the driving frequency. The data driver 120 may generate the data voltage VDAT based on a low-frequency gamma voltage VGM_L at a low driving frequency FRQ_L, and may generate the data voltage VDAT based on a high-frequency gamma voltage VGM_H at a high driving frequency FRQ_H higher than the low driving frequency FRQ_L. The low-frequency gamma voltage VGM_L and the high-frequency gamma voltage VGM_H may be different from each other for the same grayscale level.

The gamma voltage generator 130 may provide the gamma voltage corresponding to the driving frequency to the data driver 120. The gamma voltage generator 130 may provide the low-frequency gamma voltage VGM_L to the data driver 120 at the low driving frequency FRQ_L, and may provide the high-frequency gamma voltage VGM_H to the data driver 120 at the high driving frequency FRQ_H.

The scan driver 140 may provide the scan signal SS to each of the pixels PX through a plurality of gate lines. The scan driver 140 may generate the scan signal SS based on a scan control signal SCNT. The scan control signal SCNT may include a scan start signal, a scan clock signal, etc. The scan-on time SOT of the scan signal SS may vary depending on the driving frequency. The scan-on time SOT may be a time during which the scan signal SS has the gate-on voltage. For example, the scan-on time SOT may increase as the driving frequency decreases. The scan driver 140 may generate the scan signal SS having a low-frequency scan-on time at the low driving frequency FRQ_L, and may generate the scan signal SS having a high-frequency scan-on time that is different from the low-frequency scan-on time at the high driving frequency FRQ_H.

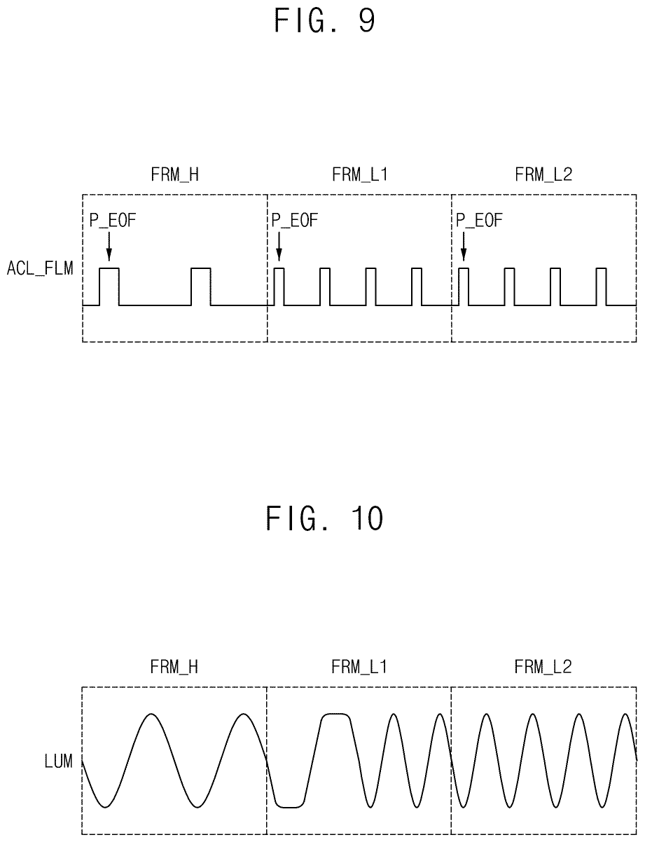

The emission driver 150 may provide the emission signal EM to each of the pixels PX through a plurality of emission signal lines. The emission driver 150 may generate the emission signal EM based on an emission control signal ECNT. The emission control signal ECNT may include an emission start signal ACL_FLM, an emission clock signal, etc. An emission cycle and an emission-off time of the emission start signal ACL_FLM may vary depending on the driving frequency. The emission cycle may be the number of emission-off periods (P_EOF of FIGS. 9, 11, 14, and 16) of the emission start signal ACL_FLM included in one frame. For example, the emission cycle may increase as the driving frequency decreases. The emission-off time may be the total duration of the emission-off periods P_EOF in one frame, or may be a ratio of the total duration of the emission-off periods P_EOF within one frame. The emission driver 150 may generate the emission signal EM having a low-frequency emission cycle and a low-frequency emission-off time at the low driving frequency FRQ_L, and may generate the emission signal EM having a high-frequency emission cycle and a high-frequency emission-off time at the high driving frequency FRQ_H.

The controller 160 may provide the second image data DAT2 and the data control signal DCNT to the data driver 120, may provide the scan control signal SCNT to the scan driver 140, and may provide the emission control signal ECNT to the emission driver 150. The controller 160 may generate the second image data DAT2, the data control signal DCNT, the scan control signal SCNT, and the emission control signal ECNT based on first image data DAT1 and a control signal CTRL.

When the driving frequency switches, the gamma voltage, the scan-on time SOT, and the emission cycle and the emission-off time of the emission start signal ACL_FLM may vary based on the driving frequency. Accordingly, in a comparative example, when the driving frequency changes, a luminance of a first frame 1st FRM after the change of the driving frequency may decrease or increase.

As illustrated in FIG. 4, when the driving frequency changes from the low driving frequency FRQ_L to the high driving frequency FRQ_H, a luminance of the first frame 1st FRM among high-frequency frames driven at the high driving frequency FRQ_H may be lower than a luminance of the last frame among low-frequency frames driven at the low driving frequency FRQ_L and a luminance of a second frame 2nd FRM among the high-frequency frames.

As illustrated in FIG. 5, when the driving frequency changes from the high driving frequency FRQ_H to the low driving frequency FRQ_L, a luminance of the first frame 1st FRM among the low-frequency frames driven at the low driving frequency FRQ_L may be higher than a luminance of the last frame among the high-frequency frames driven at the high driving frequency FRQ_H and a luminance of a second frame 2nd FRM among the low-frequency frames. Further, since a frame length increases as the driving frequency decreases, the change in luminance may be easily recognized in the low-frequency frame compared to the high-frequency frame.

The change in luminance that occurs during the transition of the driving frequency may be recognized as flashing, and thus, image quality may deteriorate at the time of the driving frequency being changed. In order to reduce or substantially prevent the deterioration of image quality that occurs when the driving frequency switches, in an embodiment of the present disclosure, the low-frequency scan-on time may be determined when a difference between a low-frequency gamma voltage range VRG_L of the low-frequency gamma voltage VGM_L and a target gamma voltage range, which is calculated based on a high-frequency gamma voltage range VRG_H of the high-frequency gamma voltage VGM_H, is within a reference range. Hereinafter, a method of controlling the low-frequency gamma voltage range VRG_L and the low-frequency scan-on time will be described with reference to FIGS. 6 and 7.

As illustrated in FIG. 6, multi-time programming (MTP) for reference grayscales may be performed (S110) at the high driving frequency FRQ_H. By performing the multi-time programming at the high driving frequency FRQ_H, the high-frequency gamma voltage VGM_H for each of the reference grayscales and the high-frequency gamma voltage range VRG_H of the high-frequency gamma voltage VGM_H may be determined. The high-frequency gamma voltage range VRG_H may be defined from a first reference high-frequency gamma voltage HV_REF1 corresponding to a first reference grayscale G_REF1 among the reference grayscales to a second reference high-frequency gamma voltage HV_REF2 corresponding to a second reference grayscale G_REF2 higher than the first reference grayscale G_REF1 among the reference grayscales.

The target gamma voltage range may be calculated (S120). The target gamma voltage range may be calculated based on the high-frequency gamma voltage range VRG_H. In an embodiment, the target gamma voltage range may be equal to the high-frequency gamma voltage range VRG_H. For example, the target gamma voltage range may be defined from a first reference high-frequency gamma voltage HV_REF1 corresponding to the first reference grayscale G_REF1 to a second reference high-frequency gamma voltage HV_REF2 corresponding to the second reference grayscale G_REF2.

The low-frequency gamma voltage range VRG_L and the low-frequency scan-on time may be determined so that the difference between the low-frequency gamma voltage range VRG_L and the high-frequency gamma voltage range VRG_H, which is the target gamma voltage range, is within the reference range. A first reference low-frequency gamma voltage LV_REF1 corresponding to the first reference grayscale G_REF1 may be searched (S130) based on an initial low-frequency scan-on time, and the searched first reference low-frequency gamma voltage LV_REF1 and the first reference high-frequency gamma voltage HV_REF1 may be compared (S140). The low-frequency scan-on time may be changed (S150) when a difference between the searched first reference low-frequency gamma voltage LV REF1 and the first reference high-frequency gamma voltage HV_REF1 is not within a reference range, and the first reference low-frequency gamma voltage LV_REF1 may be searched again (S130) based on the changed low-frequency scan-on time. A second reference low-frequency gamma voltage LV_REF2 corresponding to the second reference grayscale G_REF2 may be searched (S160) based on the low-frequency scan-on time when the difference between the searched first reference low-frequency gamma voltage LV_REF1 and the first reference high-frequency gamma voltage HV_REF1 is within the reference range, and the searched second reference low-frequency gamma voltage LV_REF2 and the second reference high-frequency gamma voltage HV_REF2 may be compared (S170). The low-frequency scan-on time may be changed (S150) when a difference between the searched second reference low-frequency gamma voltage LV_REF2 and the second reference high-frequency gamma voltage HV_REF2 is not within a reference range, and the first reference low-frequency gamma voltage LV_REF1 may be searched again (S130) based on the changed low-frequency scan-on time. The low-frequency gamma voltage range VRG_L of the low-frequency gamma voltage VGM_L and the low-frequency scan-on time may be determined when the difference between the searched second reference low-frequency gamma voltage LV_REF2 and the second reference high-frequency gamma voltage HV_REF2 is within the reference range.

Multi-time programming (MTP) may be performed (S180) for the remaining reference grayscales except for the first reference grayscale G_REF1 and the second reference grayscale G_REF2 among the reference grayscales at the low driving frequency FRQ_L. By performing the multi-time programming at the low driving frequency FRQ_L, the low-frequency gamma voltage VGM_L for each of the remaining reference grayscales except for the first reference grayscale G_REF1 and the second reference grayscale G_REF2 may be determined.

In an embodiment, the low-frequency scan-on time may decrease by an offset when the low-frequency gamma voltage range VRG_L is higher than the target gamma voltage range, and the low-frequency scan-on time may increase by the offset when the low-frequency gamma voltage range VRG_L is lower than the target gamma voltage range. When the difference between the first reference low-frequency gamma voltage LV_REF1 and the first reference high-frequency gamma voltage HV_REF1 is not within the reference range and the first reference low-frequency gamma voltage LV_REF1 is higher than the first reference high-frequency gamma voltage HV_REF1, the low-frequency scan-on time may decrease by the offset. When the difference between the first reference low-frequency gamma voltage LV_REF1 and the first reference high-frequency gamma voltage HV_REF1 is not within the reference range and the first reference low-frequency gamma voltage LV_REF1 is lower than the first reference high-frequency gamma voltage HV_REF1, the low-frequency scan-on time may increase by the offset. When the difference between the second reference low-frequency gamma voltage LV_REF2 and the second reference high-frequency gamma voltage HV_REF2 is not within the reference range and the second reference low-frequency gamma voltage LV_REF2 is higher than the second reference high-frequency gamma voltage HV_REF2, the low-frequency scan-on time may decrease by the offset. When the difference between the second reference low-frequency gamma voltage LV_REF2 and the second reference high-frequency gamma voltage HV_REF2 is not within the reference range and the second reference low-frequency gamma voltage LV_REF2 is lower than the second reference high-frequency gamma voltage HV_REF2, the low-frequency scan-on time may increase by the offset. As illustrated in FIG. 7, the low-frequency scan-on time may increase by the offset when the low-frequency gamma voltage range VRG_L is lower than the target gamma voltage range. As a result, the increased first reference low-frequency gamma voltage LV_REF1 and the increased second reference low-frequency gamma voltage LV_REF2 may be searched.

In an embodiment, the offset may be determined according to a difference between the low-frequency gamma voltage range VRG_L and the target gamma voltage range. For example, the offset may increase as the difference between the low-frequency gamma voltage range VRG_L and the target gamma voltage range increases, and may decrease as the difference between the low-frequency gamma voltage range VRG_L and the target gamma voltage range decreases.

In an embodiment, the offset may have a predetermined value. For example, the offset may have a constant value regardless of the difference between the low-frequency gamma voltage range VRG_L and the target gamma voltage range.

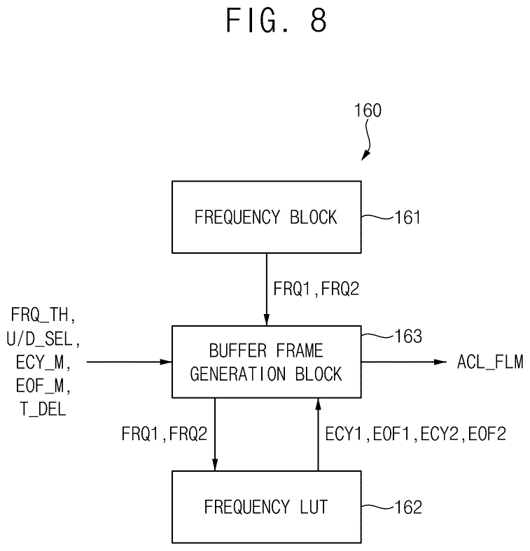

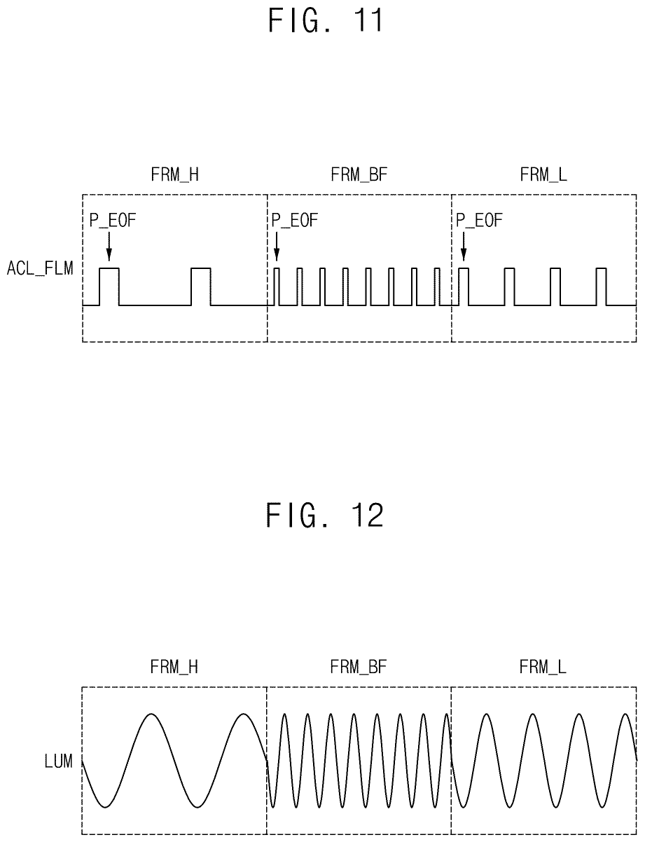

FIG. 8 is a block diagram showing an example of the controller 160 of FIG. 1. FIG. 9 is a timing diagram showing the emission start signal ACL_FLM when the driving frequency switches according to a comparative example. FIG. 10 is a timing diagram showing a luminance LUM of an image when the driving frequency switches according to a comparative example. FIG. 11 is a timing diagram showing the emission start signal ACL FLM when the driving frequency switches according to an embodiment. FIG. 12 is a timing diagram showing the luminance LUM of the image when the driving frequency switches according to an embodiment.

Referring to FIGS. 8 to 12, when the driving frequency changes between the low driving frequency FRQ_L and the high driving frequency FRQ_H, a buffer frame FRM_BF may be inserted between a low-frequency frame FRM_L driven at the low driving frequency FRQ_L and a high-frequency frame FRM_H driven at the high driving frequency FRQ_H. A buffer emission cycle of the emission start signal ACL_FLM in the buffer frame FRM_BF may be calculated based on a low-frequency emission cycle of the emission start signal ACL_FLM in the low-frequency frame FRM_L and a high-frequency emission cycle of the emission start signal ACL_FLM in the high-frequency frame FRM_H. Further, a buffer emission-off time of the emission start signal ACL_FLM in the buffer frame FRM_BF may be calculated based on a low-frequency emission-off time of the emission start signal ACL_FLM in the low-frequency frame FRM_L and a high-frequency emission-off time of the emission start signal ACL_FLM in the high-frequency frame FRM_H. In order to calculate the buffer emission cycle and the buffer emission-off time of the emission start signal ACL_FLM in the buffer frame FRM_BF, in an embodiment, the controller 160 may include a frequency block 161, a frequency lookup table (LUT) 162, and a buffer frame generation block 163.

The frequency block 161 may transmit a first driving frequency FRQ1, which is the driving frequency before a change of the driving frequency, and a second driving frequency FRQ2, which is the driving frequency after the change, to the buffer frame generation block 163 when the driving frequency switches. The frequency LUT 162 may store predetermined emission cycles and emission-off times according to the driving frequency. The frequency LUT 162 may transmit a first emission cycle ECY1 and a first emission-off time EOF1 corresponding to the first driving frequency FRQ1, and a second emission cycle ECY2 and a second emission-off time EOF2 corresponding to the second driving frequency FRQ2 to the buffer frame generation block 163.

The buffer frame generation block 163 may calculate the buffer emission cycle and the buffer emission-off time of the emission start signal ACL_FLM in the buffer frame FRM_BF based on the first driving frequency FRQ1, the second driving frequency FRQ2, the first emission cycle ECY1, the first emission-off time EOF1, the second emission cycle ECY2, the second emission-off time EOF2, a threshold frequency FRQ_TH, an up/down selection signal U/D_SEL, a manual emission cycle ECY_M, a manual emission-off time EOF_M, and a delay time duration T_DEL, and may generate the emission start signal ACL_FLM based on the calculated buffer emission cycle and the buffer emission-off time.

In an embodiment, the buffer emission cycle may be an average value of the low-frequency emission cycle and the high-frequency emission cycle. The buffer frame generation block 163 may calculate the buffer emission cycle as an average value of the first emission cycle ECY1 and the second emission cycle ECY2.

In an embodiment, the buffer emission-off time may be an average value of the low-frequency emission-off time and the high-frequency emission-off time. The buffer frame generation block 163 may calculate the buffer emission-off time as an average value of the first emission-off time EOF1 and the second emission-off time EOF2.

In an embodiment, the buffer emission cycle may be a value obtained by multiplying a weighted value to an average value of the low-frequency emission cycle and the high-frequency emission cycle. The buffer frame generation block 163 may calculate the buffer emission cycle as a value obtained by multiplying the weighted value to an average value of the first emission cycle ECY1 and the second emission cycle ECY2.

In an embodiment, the buffer emission-off time may be a value obtained by multiplying a weighted value to an average value of the low-frequency emission-off time and the high-frequency emission-off time. The buffer frame generation block 163 may calculate the buffer emission-off time as a value obtained by multiplying the weighted value to an average value of the first emission-off time EOF1 and the second emission-off time EOF2.

In an embodiment, the buffer emission cycle during a transition from the low driving frequency FRQ_L to the high driving frequency FRQ_H may be different from the buffer emission cycle during a transition from the high driving frequency FRQ_H to the low driving frequency FRQ_L. Further, the buffer emission-off time during the transition from the low driving frequency FRQ_L to the high driving frequency FRQ_H may be different from the buffer emission-off time during the transition from the high driving frequency FRQ_H to the low driving frequency FRQ_L. An external lookup table may store a first set of manual emission cycle ECY_M and manual emission-off time EOF_M which corresponds to a case where the driving frequency switches from the low driving frequency FRQ_L to the high driving frequency FRQ_H, and a second set of manual emission cycle ECY_M and manual emission-off time EOF_M which corresponds to a case where the driving frequency changes from the high driving frequency FRQ_H to the low driving frequency FRQ_L. The buffer frame generation block 163 may refer to the first set of the manual emission cycle ECY_M and the manual emission-off time EOF_M, stored in the lookup table, when the driving frequency changes from the low driving frequency FRQ_L to the high driving frequency FRQ_H, and may determine searched manual emission cycle ECY_M and manual emission-off time EOF_M, among the first set, as the buffer emission cycle and the buffer emission-off time. The buffer frame generation block 163 may refer to the second set of the manual emission cycle ECY_M and the manual emission-off time EOF_M, stored in the lookup table, when the driving frequency changes from the high driving frequency FRQ_H to the low driving frequency FRQ_L, and may determine searched manual emission cycle ECY_M and manual emission-off time EOF_M, among the second set, as the buffer emission cycle and the buffer emission-off time.

In an embodiment, the buffer frame FRM_BF may be inserted when a difference between the low driving frequency FRQ_L and the high driving frequency FRQ_H is higher than the threshold frequency FRQ_TH. In other words, the buffer frame FRM_BF may not be inserted when the difference between the low driving frequency FRQ_L and the high driving frequency FRQ_H is lower than the threshold frequency FRQ_TH. If the difference between the low driving frequency FRQ_L and the high driving frequency FRQ_H is lower than the threshold frequency FRQ_TH, abnormal emission may not be recognized during the transition of the driving frequency, and thus, an insertion of the buffer frame FRM_BF may not be performed.

In an embodiment, the buffer frame FRM_BF may be selectively inserted when the driving frequency switches from the low driving frequency FRQ_L to the high driving frequency FRQ_H or when the driving frequency switches from the high driving frequency FRQ_H to the low driving frequency FRQ_L. The buffer frame generation block 163 may selectively insert the buffer frame FRM_BF when the driving frequency changes the low driving frequency FRQ_L to the high driving frequency FRQ_H or when the driving frequency changes from the high driving frequency FRQ_H to the low driving frequency FRQ_L based on the up/down selection signal U/D_SEL.

In an embodiment, an insertion time of the buffer frame FRM_BF may be delayed by a predetermined delay time duration T_DEL from a transition time of the driving frequency. The buffer frame generation block 163 may delay a start of a first emission-off period P_EOF of the emission start signal ACL_FLM in the buffer frame FRM_BF based on the delay time duration T_DEL to delay an insertion time of the buffer frame FRM_BF.

In a comparative example, as illustrated in FIGS. 9 and 10, when the driving frequency changes from the high driving frequency FRQ_H to the low driving frequency FRQ_L, an unintended luminance waveform may occur in a first low-frequency frame FRM_L1 among low-frequency frames FRM_L1 and FRM_L2. For example, an abnormal luminance waveform may appear at the beginning of the first low-frequency frame FRM_L1, making the change of the driving frequency be recognized to the user.

In an embodiment of the present disclosure, as illustrated in FIGS. 11 and 12, when the buffer frame FRM_BF is inserted between a high-frequency frame FRM_H and a low-frequency frame FRM_L, an occurrence of the unintended luminance waveform may be mitigated. For example, as illustrated in FIG. 12, as the buffer emission cycle of the emission start signal ACL_FLM in the buffer frame FRM_BF increases (as the buffer emission cycle of the emission start signal ACL_FLM in the buffer frame FRM_BF is greater than the high-frequency emission cycle of the emission start signal ACL_FLM in the high-frequency frame FRM_H and the low-frequency emission cycle of the emission start signal ACL_FLM in the low-frequency frame FRM_L), an abnormal luminance waveform that may occur at the beginning of the change of the driving frequency may be dispersed. As a result, the user may not perceive the transition of the driving frequency of the display device.

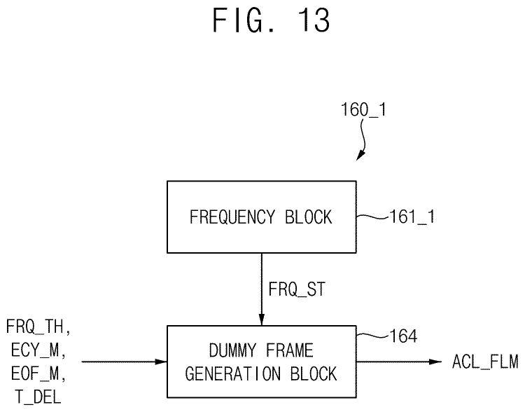

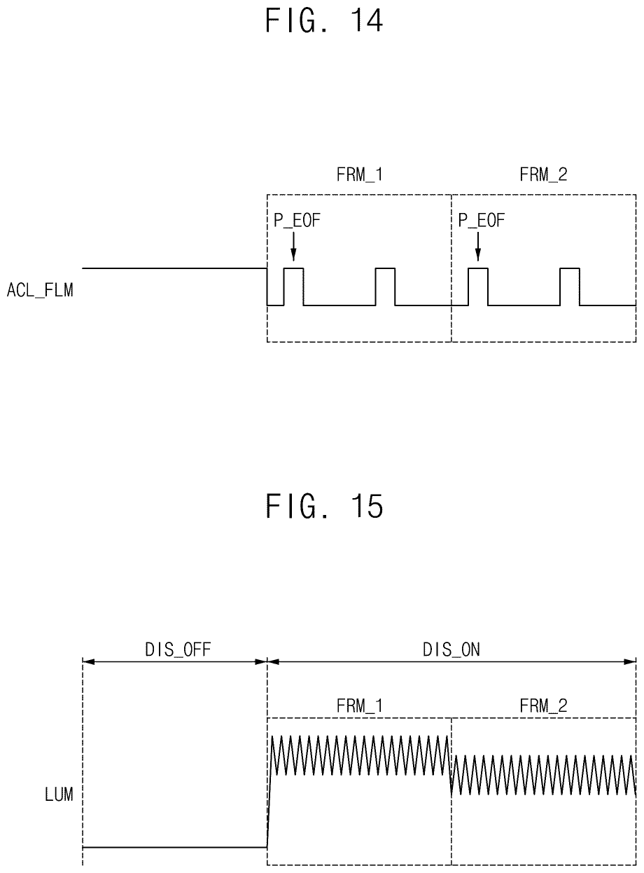

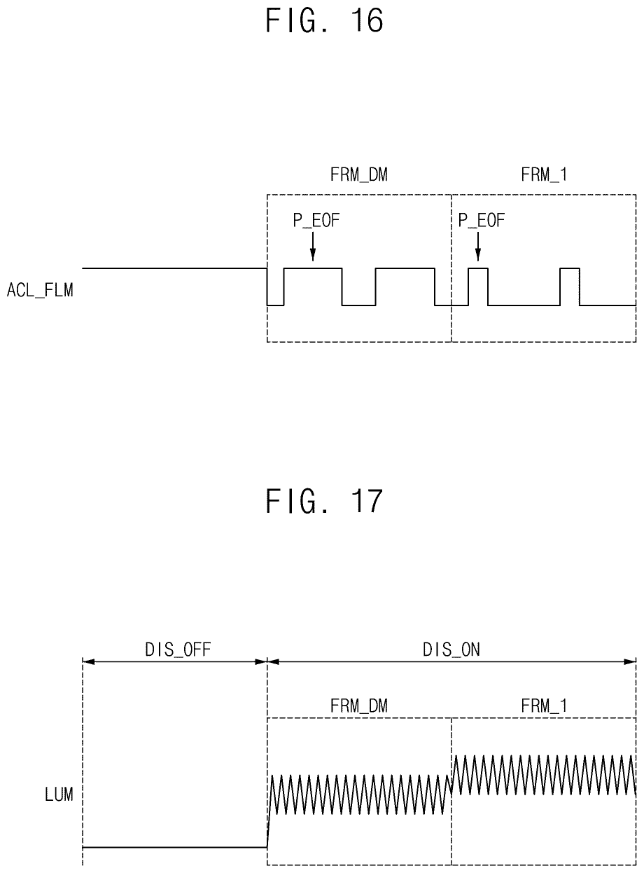

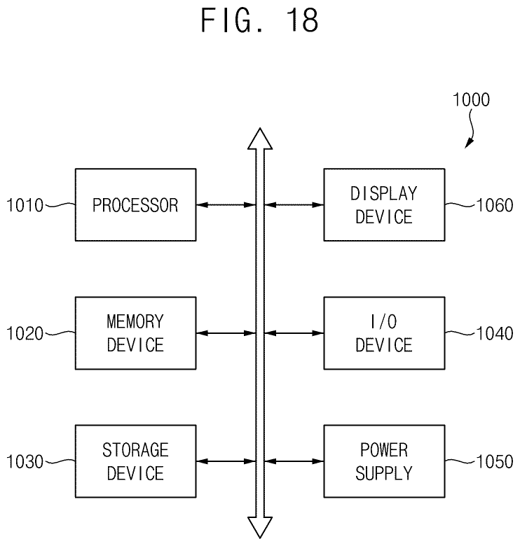

FIG. 13 is a block diagram showing an example of the controller 160_1 of FIG. 1. FIG. 14 is a timing diagram showing the emission start signal ACL_FLM when switching from a display-off state DIS_OFF to a display-on state DIS_ON according to a comparative example. FIG. 15 is a timing diagram showing the luminance LUM of the image when switching from the display-off state DIS_OFF to the display-on state DIS_ON according to a comparative example. FIG. 16 is a timing diagram showing the emission start signal ACL_FLM when switching from the display-off state DIS_OFF to the display-on state DIS_ON according to an embodiment. FIG. 17 is a timing diagram showing the luminance LUM of the image when switching from the display-off state DIS_OFF to the display-on state DIS_ON according to an embodiment.

Referring to FIGS. 13 to 17, when the display panel 110 switches from a display-off state DIS_OFF to a display-on state DIS_ON, a dummy frame FRM_DM may be inserted before a start frame FRM_1 driven at a start driving frequency FRQ_ST. At least one of the emission cycle and the emission-off time of the emission start signal ACL_FLM may be different between the start frame FRM_1 and the dummy frame FRM_DM. In order to calculate a dummy emission cycle and a dummy emission-off time of the emission start signal ACL_FLM in the dummy frame FRM_DM, in an embodiment, the controller 160_1 may include a frequency block 161_1 and a dummy frame generation block 164.

The frequency block 161_1 may transmit the start driving frequency FRQ_ST of the start frame FRM_1 to the buffer frame generation block 163 when the display panel 110 switches from the display-off state DIS_OFF to the display-on state DIS_ON.

The dummy frame generation block 164 may calculate the dummy emission cycle and the dummy emission-off time of the emission start signal ACL_FLM in the dummy frame FRM_DM based on the start driving frequency FRQ_ST, a threshold frequency FRQ_TH, a manual emission cycle ECY_M, a manual emission-off time EOF_M, and a delay time duration T_DEL, and may generate the emission start signal ACL_FLM based on the calculated dummy emission cycle and the dummy emission-off time.

In an embodiment, the dummy emission-off time of the emission start signal ACL_FLM in the dummy frame FRM_DM may be greater than a start emission-off time of the emission start signal ACL_FLM in the start frame FRM_1. In an embodiment, the dummy emission cycle of the emission start signal ACL_FLM in the dummy frame FRM_DM may be greater than a start emission cycle of the emission start signal ACL_FLM in the start frame FRM_1.

In an embodiment, the dummy frame generation block 164 may calculate the dummy emission cycle and the dummy emission-off time in a manual mode. The dummy frame generation block 164 may determine the dummy emission cycle and the dummy emission-off time as the manual emission cycle ECY_M and the manual emission-off time EOF_M, respectively, in the manual mode.

In an embodiment, the dummy frame generation block 164 may calculate the dummy emission cycle and the dummy emission-off time in an automatic mode. In the automatic mode, the dummy frame FRM_DM may be inserted when the start driving frequency FRQ_ST is lower than the threshold frequency FRQ_TH. In other words, in the automatic mode, the dummy frame FRM_DM may not be inserted when the start driving frequency FRQ_ST is higher than the threshold frequency FRQ_TH. When the start driving frequency FRQ_ST is higher than the threshold frequency FRQ_TH, abnormal emission may not be recognized in the start frame FRM_1, and thus, an insertion of the dummy frame FRM_DM may not be performed.

In an embodiment, an insertion time of the dummy frame FRM_DM may be delayed by a predetermined delay time duration T_DEL from a starting time of the display-on state DIS_ON. The dummy frame generation block 164 may delay a start of a first emission-off period P_EOF of the emission start signal ACL_FLM in the dummy frame FRM_DM based on the delay time duration T_DEL to delay an insertion time of the dummy frame FRM_DM.

In a comparative example, as illustrated in FIGS. 14 and 15, when the display panel switches from the display-off state DIS_OFF to the display-on state DIS_ON, a luminance LUM of an image may increase in a first start frame FRM_1 among start frames FRM_1 and FRM_2. For example, a luminance of an image in the first start frame FRM_1 may be higher than a luminance of the image in the second start frame FRM_2, and accordingly, a start of the display-on state DIS_ON may be recognized by the user.

In an embodiment of the present disclosure, as illustrated in FIGS. 16 and 17, when the dummy frame FRM_DM is inserted before the start frame FRM_1, a luminance LUM of an image in the display-on state DIS_ON may be prevented from increasing. For example, as illustrated in FIG. 17, as the dummy emission-off time of the emission start signal ACL_FLM in the dummy frame FRM_DM increases (as the dummy emission-off time of the emission start signal ACL_FLM in the dummy frame FRM_DM is greater than the start emission-off time of the emission start signal ACL_FLM in the start frame FRM_1), the luminance LUM of the image in the display-on state DIS_ON may not increase. As a result, the user may not perceive the start of the display-on state DIS_ON.

FIG. 18 is a block diagram showing an electronic apparatus 1000 according to an embodiment.

Referring to FIG. 18, an electronic apparatus 1000 may include a processor 1010, a memory device 1020, a storage device 1030, an input/output (I/O) device 1040, a power supply 1050, and a display device 1060. The electronic apparatus 1000 may further include a plurality of ports capable of communicating with a video card, a sound card, a memory card, a USB device, or the like, or communicating with other systems.

The processor 1010 may perform specific calculations or tasks. According to an embodiment, the processor 1010 may be a microprocessor, a central processing unit (CPU), or the like. The processor 1010 may be connected to other components through an address bus, a control bus, a data bus, or the like. According to an embodiment, the processor 1010 may also be connected to an expansion bus such as a peripheral component interconnect (PCI) bus.

The processor 1010 may control the display device 1060. In an embodiment, the processor 1010 may provide the first image data DAT1 of FIG. 1 and the control signal CTRL of FIG. 1 to the display device 1060.

The memory device 1020 may store data required for an operation of the electronic apparatus 1000. For example, the memory device 1020 may include a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM), or a volatile memory device such as a dynamic random access memory (DRAM), a static random access memory (SRAM), or a mobile DRAM.

The storage device 1030 may include a solid state drive (SSD), a hard disk drive (HDD), a CD-ROM, or the like. The I/O device 1040 may include an input device such as a keyboard, a keypad, a touch pad, a touch screen, or a mouse, and an output device such as a speaker or a printer. The power supply 1050 may supply a power required for the operation of the electronic apparatus 1000. The display device 1060 may be connected to other components through the buses or other communication links. The display device 1060 may correspond to the display device 100 of FIG. 1.

The display device according to the embodiments may be applied to a display device included in a computer, a notebook, a mobile phone, a smart phone, a smart pad, a smart watch, a PMP, a PDA, an MP3 player, or the like.

Although the display device and the electronic apparatus according to the embodiments have been described with reference to the drawings, the embodiments shown above are examples, and may be modified and changed by a person having ordinary knowledge in the relevant technical field without departing from the technical spirit described in the following claims.

What is claimed is:

1. A display device, comprising:
a display panel including a pixel;
a data driver connected to the pixel through a data line, the data driver generating a first data voltage for a low driving frequency based on a low-frequency gamma voltage, generating a second data voltage for a high driving frequency higher than the low driving frequency based on a high-frequency gamma voltage, and providing the first data voltage or the second data voltage to the pixel; and
a scan driver connected to the pixel through a gate line, the scan driver generating a first scan signal for the low driving frequency having a low-frequency scan-on time, generating a second scan signal for the high driving frequency having a high-frequency scan-on time different from the low-frequency scan-on time, and providing the first scan signal or the second scan signal to the pixel,
wherein the low-frequency scan-on time is determined when a difference between a low-frequency gamma voltage range of a low-frequency gamma voltage and a target gamma voltage range calculated based on a high-frequency gamma voltage range of a high-frequency gamma voltage is within a reference range.

2. The display device of claim 1, wherein the target gamma voltage range is equal to the high-frequency gamma voltage range.

3. The display device of claim 2, wherein the low-frequency gamma voltage range is defined from a first reference low-frequency gamma voltage corresponding to a first reference grayscale to a second reference low-frequency gamma voltage corresponding to a second reference grayscale higher than the first reference grayscale, and
wherein the target gamma voltage range is defined from a first reference high-frequency gamma voltage corresponding to the first reference grayscale to a second reference high-frequency gamma voltage corresponding to the second reference grayscale.

4. The display device of claim 2, wherein the low-frequency scan-on time decreases by an offset when the low-frequency gamma voltage range is higher than the target gamma voltage range, and
wherein the low-frequency scan-on time increases by the offset when the low-frequency gamma voltage range is lower than the target gamma voltage range.

5. The display device of claim 4, wherein the offset is determined based on a difference between the low-frequency gamma voltage range and the target gamma voltage range.

6. The display device of claim 4, wherein the offset has a predetermined value.

7. The display device of claim 1, further comprising:
an emission driver connected to the pixel through an emission signal line, the emission driver generating an emission signal based on an emission start signal having an emission cycle that varies depending on a driving frequency and providing the emission signal to the pixel; and
a controller generating the emission start signal.

8. The display device of claim 7, wherein a buffer frame is inserted between a low-frequency frame driven at the low driving frequency and a high-frequency frame driven at the high driving frequency when the driving frequency changes between the low driving frequency and the high driving frequency, and
wherein a buffer emission cycle of the emission start signal in the buffer frame is calculated based on a low-frequency emission cycle of the emission start signal in the low-frequency frame and a high-frequency emission cycle of the emission start signal in the high-frequency frame.

9. A display device, comprising:
a display panel including a pixel;
an emission driver connected to the pixel through an emission signal line, the emission driver generating an emission signal based on an emission start signal having an emission cycle that varies depending on a driving frequency and providing the emission signal to the pixel; and
a controller generating the emission start signal,
wherein a buffer frame is inserted between a low-frequency frame driven at a low driving frequency and a high-frequency frame driven at a high driving frequency higher than the low driving frequency when the driving frequency changes between the low driving frequency and the high driving frequency, and
wherein a buffer emission cycle of the emission start signal in the buffer frame is calculated based on a low-frequency emission cycle of the emission start signal in the low-frequency frame and a high-frequency emission cycle of the emission start signal in the high-frequency frame.

10. The display device of claim 9, wherein the buffer emission cycle is an average value of the low-frequency emission cycle and the high-frequency emission cycle.

11. The display device of claim 9, wherein the buffer emission cycle is obtained by multiplying a weighted value to an average value of the low-frequency emission cycle and the high-frequency emission cycle.

12. The display device of claim 9, wherein the buffer emission cycle when the driving frequency changes from the low driving frequency to the high driving frequency is different from the buffer emission cycle when the driving frequency changes from the high driving frequency to the low driving frequency.

13. The display device of claim 9, wherein the buffer frame is inserted when a difference between the low driving frequency and the high driving frequency is higher than a threshold frequency.

14. The display device of claim 9, wherein the buffer frame is selectively inserted when the driving frequency changes from the low driving frequency to the high driving frequency or when the driving frequency changes from the high driving frequency to the low driving frequency.

15. The display device of claim 9, wherein an inserting time of the buffer frame is delayed by a delay time duration from a transition time of the driving frequency.

16. A display device, comprising:
a display panel including a pixel;
an emission driver connected to the pixel through an emission signal line, the emission driver generating an emission signal based on an emission start signal having an emission cycle and an emission-off time which vary depending on a driving frequency and providing the emission signal to the pixel; and
a controller generating the emission start signal,
wherein a dummy frame is inserted before a start frame driven at a start driving frequency when the display panel switches from a display-off state to a display-on state, and
wherein at least one of the emission cycle and the emission-off time is different between the start frame and the dummy frame.

17. The display device of claim 16, wherein a dummy emission-off time of the emission start signal in the dummy frame is greater than a start emission-off time of the emission start signal in the start frame.

18. The display device of claim 16, wherein a dummy emission cycle of the emission start signal in the dummy frame is greater than a start emission cycle of the emission start signal in the start frame.

19. The display device of claim 16, wherein the dummy frame is inserted when the start driving frequency is lower than a threshold frequency.

20. The display device of claim 16, wherein an inserting time of the dummy frame is delayed by a delay time duration from a starting time of the display-on state.

21. An electronic apparatus including a display device which displays an image and a processor which controls the display device, the electronic apparatus comprising:
a display panel including a pixel;
a data driver connected to the pixel through a data line, the data driver generating a first data voltage for a low driving frequency based on a low-frequency gamma voltage, generating a second data voltage for a high driving frequency higher than the low driving frequency based on a high-frequency gamma voltage, and providing the first data voltage or the second data voltage to the pixel; and
a scan driver connected to the pixel through a gate line, the scan driver generating a first scan signal for the low driving frequency having a low-frequency scan-on time, generating a second scan signal for the high driving frequency having a high-frequency scan-on time different from the low-frequency scan-on time, and providing the first scan signal or the second scan signal to the pixel,
wherein the low-frequency scan-on time is determined when a difference between a low-frequency gamma voltage range of a low-frequency gamma voltage and a target gamma voltage range calculated based on a high-frequency gamma voltage range of a high-frequency gamma voltage is within a reference range.
